(19) United States
(12) Patent Application Publication
(10) Pub. No.: US 2012/0163663 A1
(43) Pub. Date: Jun. 28, 2012

(54) SECURITY USE RESTRICTIONS FOR A MEDICAL COMMUNICATION MODULE AND HOST DEVICE

(75) Inventors: Javaid Masoud, Shoreview, MN (US); Gregory J. Haubrich, Champlin, MN (US); William D. Verhoef, Andover, MN (US); Bo Zhang, Blaine, MN (US); Christopher M. Petersen, Ham Lake, MN (US)

(73) Assignee: Medtronic, Inc.

(21) Appl. No.: 13/336,383

(22) Filed: Dec. 23, 2011

Related U.S. Application Data
(60) Provisional application No. 61/427,370, filed on Dec. 27, 2010.

(51) Int. Cl. G06F 15/16; G06K 9/62

(52) U.S. Cl. 382/103; 709/204

(57) ABSTRACT

System and method for interfacing with a medical device. The system has a host device and a communication module. The host device has a user interface configured to input and display information relating to the interfacing with the medical device. The communication module is locally coupled to the host device and configured to communicate wirelessly with the medical device. The system, implemented by the host device and the communication module, is configured to communicate with the medical device with functions. The system, implemented by at least one of the host device and the communication module, has validation layers configured for use by users, each of the users having access to at least one of the validation layers based on a validation condition, each individual one of the functions being operational through the user interface only with one of the validation layers.

### RELATED APPLICATION

This application claims priority from U.S. Provisional Application No. 61/427,370, filed on Dec. 27, 2010, entitled “SECURITY USE RESTRICTIONS FOR A MEDICAL COMMUNICATION MODULE AND HOST DEVICE”.

### FIELD

The present invention related generally to medical communication devices and, more particularly, to devices to communicate with a medical device.

### BACKGROUND

Commercial consumer electronic devices or other so-called “off-the-shelf” electronic devices for providing computing operations and communications, both wired and wireless, are well known in the art. Devices such as personal digital assistants (“PDAs”), “smartphones” and tablet personal computers provide computing power, digital storage and user input/output functionality in what is, typically, a size and weight which is conducive to easy portability by an individual user. In addition, so-called “netbooks”, as well as notebook and laptop computers, may provide similar functionality, albeit commonly in a larger form-factor and with greater weight.

Commonly, such devices listed above incorporate a communications module or communications modules to allow the devices to communicate over various wireless communications bands. Standards such as Bluetooth, IEEE 802.11, cellular, among others known in the art, provide both protocols and designated frequencies over which communications may occur. In addition, proprietary communications schemes may be developed and fielded independently. Communications modules designed to be consistent with such commercial and proprietary standards may be incorporated into such devices to permit them to communicate wirelessly with other devices similarly designed to communicate according to the various standards.

Electrically active medical devices may similarly be configured to communicate according to commercial and proprietary communication standards. Such medical devices may be involved in communications to transmit data relating to the condition of the medical device as well as the condition of the patient with which the device is associated. In addition, the medical device may be involved with communications to receive commands from external sources pertaining to the function of the medical device, for instance to reprogram the medical device from a first configuration setting to a second configuration setting. The Medical Implant Communication Service (“MICS”) band is commonly used to communicate with an implanted medical device. The Medical Data Service (“MEDS”) is an ultra-low power medical device communication system using the 401-402 megaHertz and/or 405-406 megaHertz bands.

But while medical devices may, like commercial devices, operate according to various communication standards, the standards according to which the medical devices operate may not advantageously be the same as those to which commercial devices operate. While a commercial device may usefully communicate according to, for instance, the Bluetooth communication standard, the power requirements of Bluetooth may make using Bluetooth disadvantageous for an implantable medical device incorporating a relatively small power source. Such an implantable medical device may advantageously utilize a proprietary communication scheme over the MICS/MEDS band instead. By contrast, a smartphone, for instance, which does not commonly communicate with implantable medical devices, and which, as such, may not profitably incorporate a MICS/MEDS band receiver, may not be able to communicate with an implantable medical device.

As a result, communications with implantable medical devices have commonly incorporated proprietary, custom-designed electronic devices instead of commercial, off-the-shelf devices. Custom designed electronic devices tend to cost relatively more for design and manufacture of relatively small numbers of proprietary devices in comparison with the number of commercial devices on the market. Because of the increased cost, there may be a motivation to minimize the number of such custom-designed devices built to a relative minimum in order to save cost. This may tend to limit availability of such custom-designed electronics, reducing a utility in providing the capabilities afforded by such electronics to users other than medical professionals in a clinical setting.

### SUMMARY

It has been determined, however, that the relative proliferation of commercial devices such as smartphones, tablet computers, notebook computers and netbooks may provide an opportunity to adapt such devices with custom-designed modules to be used with existing or future commercial devices for communication with medical devices. By virtue of not being complete user-operable devices, such proprietary modules may be relatively inexpensive to manufacture and distribute. By adapting the performance of commercial devices with proprietary modules, the utility which may be provided with proprietary modules may be made available to a wide range of users beyond medical professionals in clinical settings, such as to the patients themselves or other healthcare providers, while remaining relatively cost effective.

By providing patients and others an ability to communicate between commercial devices and medical devices, patients, medical professionals and medical devices may obtain greater exposure to information which may benefit the treatment of the patient. By providing modules to adapt commercial electronic devices for use interfacing with and presenting information from implantable medical devices and conducting interviews and follow-ups between patients and physicians, relatively greater information and ability to interact between and among various devices and entities may be available than has been available in the past. Such information and interaction may further be made available at relatively reduced cost to health care systems than has previously been possible or realistic.

Device applications may be utilized an impact performance in such circumstances. Programs which run on the commercial device may or may not have relevance to utilizing or interfacing with the medical device. To the extent that such applications are useful, they may be managed to reduce a likelihood of being improperly utilized. To the extent that such applications are not useful, they may be managed to reduce a likelihood of interference with applications which are relevant to utilizing or interfacing with the medical device.

However, the potential proliferation of communication modules configured to be utilized with commonly available host devices may create patient and data security issues which may be improbable or impossible when utilizing primarily proprietary devices. In particular, if a communication module is obtained by a third party, the third party may be able to access sensitive patient data or impact medical device operations unless effective security measures are implemented. Of potentially equal concern is the reality that because patients themselves will desirably have access to such communication modules, the patients may undesirably vary the operation of their own medical devices without restrictions on their access to the functionality of their communication modules. Security features have therefore been developed which will permit the wide dissemination of communication modules to varying types of users of such devices but which restrict availability of communication module functionality based on various factors.

In an embodiment, a system for interfacing with a medical device has a host device and a communication module. The host device has a user interface configured to input and display information relating to the interfacing with the medical device. The communication module is locally coupled to the host device and configured to communicate wirelessly with the medical device. The system, implemented by the host device and the communication module, is configured to communicate with the medical device with a plurality of functions. The system, implemented by at least one of the host device and the communication module, has a plurality of validation layers configured for use by a plurality of users, each of the plurality of users having access to at least one of the plurality of validation layers based on a validation condition, each individual one of the plurality of functions being operational through the user interface only with one of the plurality of validation layers.

In an embodiment, each individual one of the plurality of users corresponds to individual ones of the plurality of validation layers based on a characteristic of the individual one of the plurality of users.

In an embodiment, one of the plurality of users is a patient and another one of the plurality of users is a medical professional, and wherein the at least one of the plurality of validation layers corresponding to the medical professional includes least one of the plurality of validation layers not corresponding to the patient.

In an embodiment, the at least one of the plurality of functions corresponding to the at least one of the plurality of validation layers corresponding to the patient provide an indication of a patient condition from the medical device.

In an embodiment, the at least one of the plurality of functions corresponding to the at least one of the plurality of validation layers corresponding to the medical professional provide modification of a performance of the medical device.

In an embodiment, a notice of a modification of the performance of the medical device is displayed on the user input to the medical professional when the modification of the performance of the medical device is modified.

In an embodiment, one of the plurality of users is a caregiver and wherein the at least one of the plurality of validation layers corresponding to the caregiver includes at least one of the plurality of validation layers not corresponding to the patient and wherein the at least one of the plurality of validation layers corresponding to the medical professional include at least one of the plurality of validation layers not corresponding to the caregiver.

In an embodiment, the system further comprises a peripheral device and wherein at least one validation condition of a corresponding one of the plurality of validation layers is based on the peripheral device being locally coupled to the system.

In an embodiment, the peripheral device is a programming head configured to communicate wirelessly with the medical device.

In an embodiment, at least one of the validation conditions is based on a first validation procedure and a second validation procedure utilized after a first use of the first validation procedure.

In an embodiment, the first validation procedure has a complexity greater than a complexity of the second validation procedure.

In an embodiment, the system for interfacing with a medical device has a host device, a communication module and a proximity sensor. The host device as a user interface configured to input and display information relating to the interfacing with the medical device. The communication module is locally coupled to the host device, the communication module having a first range and being configured to communicate via radio frequency with the medical device. The proximity sensor is locally coupled to the host device and the communication module, the proximity sensor having a second range being less than the first range and an activation criterion. The system interfaces with the medical device only upon the activation criterion being met.

In an embodiment, the proximity sensor is operatively coupled to the user interface and wherein an action on the user interface further provides the activation criterion.

In an embodiment, the system further has a camera having an output and an image recognition block operatively coupled to the output of the camera. The activation criterion is based on the image recognition block recognizing a predetermined image.

In an embodiment, the image recognition block is a facial recognition block configured to recognize a face of at least one of a patient, a caregiver and a medical professional.

In an embodiment, the image recognition block is configured to recognize a biometric attribute of a user.

In an embodiment, the system further comprises a fingerprint reader having an output and an fingerprint recognition block operatively coupled to the output of the fingerprint reader. The activation criterion is based on the fingerprint recognition block recognizing a predetermined fingerprint.

In an embodiment, the fingerprint recognition block is a fingerprint recognition block configured to recognize a fingerprint of at least one of a patient, a caregiver and a medical professional.

In an embodiment, method is provided for interfacing with a medical device. The method uses a host device and a communication module together configured to communicate with the medical device with a plurality of functions, the host device comprising a user interface configured to input and display information relating to the interfacing with the medical device, the communication module being locally coupled to the host device and configured to communicate wirelessly with the medical device, at least one of the host device and the communication module has a plurality of validation layers, configured for use by a plurality of users, each of the users having access to individual ones of the plurality of validation layers based on a validation condition, each individual one of the plurality of functions being associated with at least one of the plurality of validation layers and being operational through the user interface only with one of the plurality of validation layers associated with the individual one of the plurality of functions. The method has the steps of entering the validation condition via the user interface and corresponding to one of the plurality of users for at least one of the plurality of validation layers and communicating with the medical device according to the at least one of the plurality of functions associated with the at least one of the plurality of validation layers upon the entering the validation condition.

In an embodiment, each individual one of the plurality of users corresponds to individual ones of the plurality of validation layers based on a characteristic of the individual one of the plurality of users.

In an embodiment, one of the plurality of users is a patient and another one of the plurality of users is a medical professional, and the communicating step comprises communicating based on the at least one of the plurality of validation layers corresponding to the medical professional including at least one of the plurality of validation layers not corresponding to the patient.

In an embodiment, the at least one of the plurality of functions corresponding to the at least one of the plurality of validation layers corresponding to the patient provide an indication of a patient condition from the medical device. The method further comprises the step, after the entering the validation condition step, of obtaining an indication of the patient condition via the user interface.

In an embodiment, the at least one of the plurality of functions corresponding to the at least one of the plurality of validation layers corresponding to the medical professional provides modification of a performance of the medical device. The method further comprises the step, after the entering the validation condition step, of modifying a performance of the medical device.

In an embodiment, the method further comprises the step of displaying a notice of a modification of the performance of the medical device on the user input to the medical professional when the modification of the performance of the medical device is modified in the modifying step.

In an embodiment, one of the plurality of users is a caregiver and wherein the at least one of the plurality of validation layers corresponding to the caregiver includes at least one of the plurality of validation layers not corresponding to the patient and wherein the at least one of the plurality of validation layers corresponding to the medical professional includes at least one of the plurality of validation layers not corresponding to the caregiver. The communicating step is based, at least in part, on the at least one of the plurality of validation layers corresponding to the caregiver.

In an embodiment, the system further has a peripheral device. The communicating step is based, at least in part, on at least one validation condition of a corresponding one of the plurality of validation layers being based on the peripheral device being locally coupled to the system.

In an embodiment, the peripheral device is a programming head configured to communicate wirelessly with the medical device. The communicating step utilizes the programming head.

In an embodiment, at least one of the validation conditions is based on a first validation procedure and a second validation procedure utilized after a first use of the first validation procedure. The entering step comprises using the first validation procedure. The method further comprises the step, after the entering step, of entering the validation condition via the user interface using the second validation procedure.

In an embodiment, the entering the validation condition via the user interface using the second validation step occurs after the communicating step.

In an embodiment, the first validation procedure has a complexity greater than a complexity of the second validation procedure.

In an embodiment, a method is provided for interfacing with a medical device. The method uses a host device, a communication module and a proximity sensor, the host device having a user interface configured to input and display information relating to the interfacing with the medical device, the communication module being locally coupled to the host device, the communication module having a first range and being configured to communicate via radio frequency with the medical device, the proximity sensor locally coupled to the host device and the communication module, the proximity sensor having a second range less than the first range and an activation criterion, wherein the system interfaces with the medical device only upon the activation criterion being met. The method has the steps of positioning the communication module within the first range of the medical device, positioning the proximity sensor within the second range of the medical device, and then interfacing with the medical device using the communication module based on the activation criterion being met.

In an embodiment, the proximity sensor is operatively coupled to the user interface. The method further comprises the steps of inputting an action on the user interface to further provide the activation criterion, and, prior to the interfacing step, of inputting the action via the user interface.

In an embodiment, the system further has a camera having an output and an image recognition block operatively coupled to the output of the camera. The method further has the step of recognizing a face of at least one of a patient, a caregiver and a medical professional using the image recognition block. The interfacing step is further based, at least in part, on the activation criterion based on the image recognition block recognizing the predetermined image step.

In an embodiment, the system further has a fingerprint reader having an output and an fingerprint recognition block operatively coupled to the output of the fingerprint reader. The method further comprises the step of recognizing a predetermined fingerprint of at least one of a patient, a caregiver and a medical professional using the fingerprint recognition block. The interfacing step is further based, at least in part, on the activation criterion being based on the fingerprint recognition block recognizing the predetermined fingerprint.

### FIGURES

FIG. 1 is an illustration of a network to interface between implantable medical devices in a patient, including therapy delivery devices and sensors, and outside receptors utilizing a communications module coupled to a host device;

FIG. 2 is an exemplary embodiment of a communications module coupled to a host device;

FIG. 3 illustrates an embodiment of a host device coupled to a module and configured to facilitate communications between an implantable medical device in a patient and a wider network;

FIG. 4 is a depiction of a graphical application for a host device configured to facilitate interfacing with implantable medical devices;

FIG. 5 is a diagram for conducting communications between the host device, the communication module and the implantable medical device;

FIG. 6 is a depiction of utilizing multiple host devices of varying types to communicate with multiple medical devices and to facilitate communications between and among the multiple medical devices, the host devices and the third-party devices over the Internet;

FIG. 7 is a depiction of an alternative embodiment of the communication module;

FIG. 8 is a is an antenna of a communication module;

FIG. 9 is an exemplary embodiment of a host device;

FIG. 10 is a functional drawing of a programming head;

FIG. 11 is a flowchart for interfacing with a medical device using a plurality of validation layers; and

FIG. 12 is a flowchart for interfacing with a medical device using a proximity sensor as in FIG. 9.

### DESCRIPTION

The entire content of U.S. Provisional Application Ser. No. 61/427,370, filed Dec. 27, 2010 is hereby incorporated by reference.

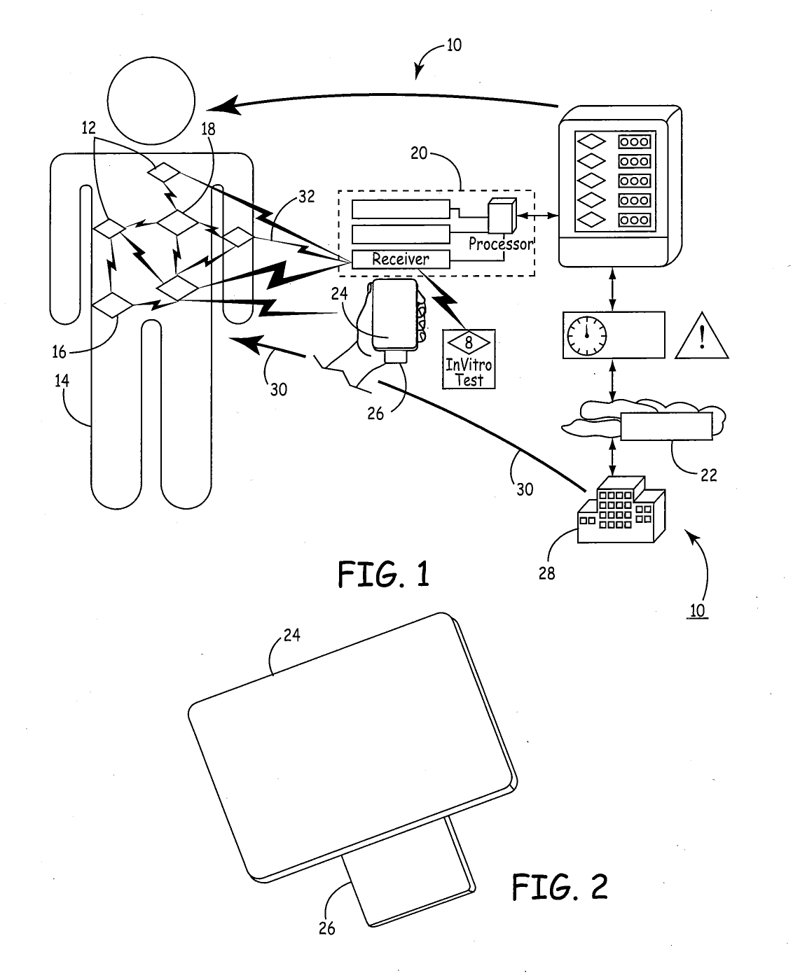

FIG. 1 is an illustration of an exemplary network 10 to interface between implantable medical devices 12 in patient 14, including therapy delivery devices 16 and sensors 18, and outside receptors 20. Information may flow from implantable medical devices 12 to external networks 22, while information and instructions may flow to implantable medical devices 12 from network 10. One device which may facilitate such information flows is the handheld consumer electronic device 24, or host, as depicted by a smartphone, for example, an iPhone™ smartphone¹ by Apple Inc. As illustrated, host 24 is operably, locally coupled to module 26 configured to facilitate communications and between and interfacing with implantable medical devices 12 and host 24. In various embodiments described below, host device 24 is locally coupled to communication module 26 either through a physical connector or by wireless communication. Alternative embodiments of host 24 are envisioned, including, but not limited to, products by Apple Inc. such as the iPod™ digital music player², iPad™ tablet computer³ and MacBook™ computer⁴, the BlackBerry™⁵ smartphone by Research-in-Motion, Ltd., the Droid™ smartphone⁶ and the Defy™ smartphone⁷ by Motorola, Inc., the Optimus™ smartphone⁸ by LG Electronics Inc., and the Evo™ smartphone⁹ and Wildfire™ smartphone¹⁰ by HTC Corp. ¹ iPhone is a trademark of Apple Inc.² iPod is a trademark of Apple Inc.³ iPad is a trademark of Apple Inc.⁴ MacBook is a trademark of Apple Inc.⁵ BlackBerry is a trademark of Research-in-Motion, Ltd.⁶ Droid is a trademark of Motorola, Inc.⁷ Defy is a trademark of Motorola, Inc.⁸ Optimus is a trademark of LG Electronics Inc.⁹ Evo is a trademark of HTC Corp.¹⁰ Wildfire is a trademark of HTC Corp.

Advantageously, the use of an off-the-shelf, commercially available consumer electronic device may provide a common and easy to use standard user interface. Such host devices 24 may incorporate a proven and robust infrastructure for the writing and dissemination of applications in support of communications module 26. Host devices 24 may incorporate a family or platform of devices which may allow for single applications which may be useful on multiple devices. In addition, such commercial devices commonly incorporate common electronic connectors, both within device platforms and families and across device platforms and manufacturers. The commercial features of host devices 24 may further be utilized in support of medical applications, such as by providing easy accessibility to email, text and other forms of electronic communication. Additionally, existing medical applications may be utilized to supplement proprietary medical applications, providing, for instance, applications for regulating patient's 14 diet, weight, blood pressure, insulin, blood glucose levels and so forth.

As illustrated, host device 24 is locally coupled to communication module 26 by way of an electronic connector (obscured). The connector may be standard for host device 24 and may be utilized by host device 24 to interface with external data sources and power supplies. In various embodiments, communication module 26 may be configured to interface with multiple different types of host devices 24, e.g., by having multiple electronic connectors or by having a common connector (for example, a USB port, that can connect to differing devices). In various alternative embodiments, each communication module 26 is configured to function with only one particular type of host device 24.

Communication module 26 may be configured to communicate wirelessly with implantable medical devices 12 in patient 14. Host device 24 and module 26 together may be configured to perform various functions relating to interfacing with medical device 12, for instance, by receiving information from one or more of implantable medical devices 12 and, in some instances, provide the received information to host device 24. Module 26 may also be configured to receive information (e.g., data or instructions) from host device 24 for transmission to implantable medical devices 12 and transmit the received information to one or more of implantable medical devices 12. Host device 24 may be variably configured to display the information received from implantable medical devices 12 and/or to forward the information received from implantable medical devices 12 to other members of network 10, illustrated or not. Host 24 may be configured to transmit the information received by way of communications methods already incorporated into host device 24. For instance, where host device 24 is a smartphone, the host device may transmit the information over a cellular network, over a WiFi network or over a physical connection such as Ethernet or modem.

Host 24 and communication module 26 may together be further variably configured to allow a user to perform functions relating to interfacing with implantable medical device 12, such as by entering instructions for transmission to implantable medical devices 12 by way of module 26. In addition, host 24 may be configured to receive instructions from a third-party device by way of host device's 24 built-in communications systems. For instance, a medical professional operating at remote site 28 may be permitted to transmit instructions 30 to host device 24 by way of the cellular system, for instance, which may then be communicated to one or more of implantable medical devices 12 by way of communications module 26.

FIG. 2 is an exemplary embodiment of communications module 26 coupled to host device 24, as illustrated a smartphone. Communications module 26 is configured with a connector which allows module 26 to be operatively connected to host device 24 according to the requirements and specifications of host device 24. As such, module 26 may be configured to be operatively connected to any similar model smartphone, in the illustrated example, interchangeably. In addition, any host device 24 with the same connection capability may be operatively connected to communications module 26.

In various embodiments, host device 24 may be configured with software, such as an application or “app” running on host device 24, to allow host device 24 to interface with communications module 26 according to the various functions described herein. Each application may correspond to one or more such function, for instance by providing a display for patient physiological data, data relating to the performance of medical device 12, and entering in programming parameters for transmittal to medical device 12, among other functions. The software may allow host device 24 to operate with module 26, display information received from implantable medical device 12 by way of module 26 and allow a user to input instructions to be transmitted to implantable medical device 12, among other functions. The software may be incorporated into module 26 and downloaded into host 24 when module 26 is plugged into host 24, or may be downloaded into host device 24 directly or remotely according to methods well known in the art.

In an embodiment, communications module 26 is configured to communicate 32 (FIG. 1) with implantable medical device 12 on the MICS/MEDS band. In one example, module 26 is approximately fifty (50) millimeters by fifty (50) millimeters and incorporates a thirty (30) pin connector. Communications module 26 incorporates one or more antennas as well as at least one processor to support communications.

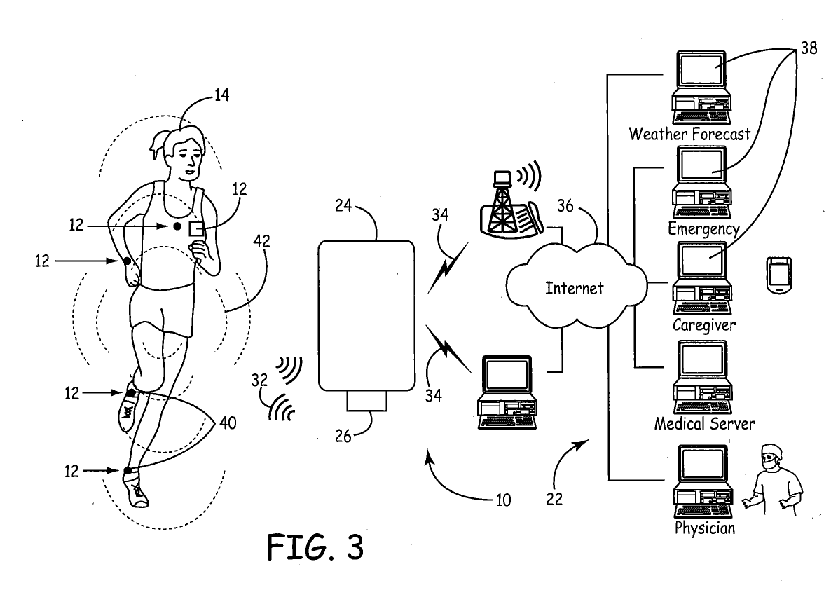

FIG. 3 illustrates an embodiment of host device 24 coupled to module 26 and configured to facilitate communications 32 between implantable medical device 12 in the patient and a wider network 22. Communications module 26 permits communication between host device 24 and implantable medical device 12 of mobile patient 14. Host device 24 permits wireless communication 34 according to various standards with the Internet 36 and thus various third-party destinations 38.

In the illustrated embodiment, host device 24 and communications module 26 may be on the person of patient 14 and transmitting as patient 14 moves around. In various embodiments, communications module 26 may be separated from implantable medical device 12 by ten (10) meters or more. However, in certain embodiments, communications module 26 may not be configured to communicate with implantable medical device 12 at ranges longer than approximately ten (10) meters and may instead have a communication range of one (1) meter or less. By contrast, host device 24 may be configured to communicate on WiFi and/or cellular bands 34, for instance, at ranges conventionally from tens of meters to multiple kilometers.

In so doing, communications module 26, coupled with host device 24, may be configured to provide global connectivity for patients with implantable medical devices 12. In various embodiments, host devices 24 which are configured to communicate over communications systems available even in relatively remote places may deliver information from patients' 14 medical devices 12 to and receive instructions from medical providers in distant places 38. In such embodiments, host devices 24 may be devices which are already possessed by patient 14 or which may be acquired at relatively modest cost. Similarly, because communications module 26 may incorporate few features and functions other than to communicate with host device 24, communications module 26 may similarly be relatively inexpensive and useable in remote areas.

In addition, the use of host devices 24 such as commercially available, “off-the-shelf” devices detailed above, may provide for patient- and physician-centric applications to support maintenance of patient's 14 implantable medical device 12 and advance patient care. Patient 14 may be provided with details of their care on host device 24 in order for patient 14 to better understand their condition and what steps patient 14 may take outside of the strict function of their implantable medical device 12 to advance their treatment. Physicians may be provided on their own devices 38, either commercial devices or purpose-built devices, information similarly related to the status of patient 14 and implantable medical device 12, and may be provided with such information conveniently and without having to directly interface with patient 14. Thus, such information may be provided conveniently and at relatively low cost. In further instances, patient 14 and the physician may use the same host device 24 with different communications modules 26 attached or the same host device 24 using the same communications module 26 with additional functionality provided to the physician (e.g., by using a password).

In particular, patient-centric applications may include monitoring and reporting to patient 14 of adverse medical events and reactions to treatment, alerts instructing patient 14 to take a particular action, and physiologic information not necessarily related to their treatment. Physiologic information may include information such as blood pressure and weight. Additional patient-centric information may include educational materials for instructing patient 14 on living with various diseases and conditions, vital signs and instruction on activities such as eating, exercise and daily health logs. Additional patient-centric applications are envisioned.

In particular, physician-centric applications may include programming capabilities for implantable medical devices 12 of patient 14, providing patient 14 with medical advice and enabling various alternative forms of communication with patient 14 and other sources. Programming capabilities may include full programming capabilities for implantable medical devices 12. Alternatively, perhaps particularly for relatively complex devices which may cause a negative impact on patient 14 in the event of a patient reaction to a new therapy, full programming of implantable medical devices 12 may be curtailed for certain, relatively more complex devices. The sharing of health and wellness information may incorporate customized data viewing capabilities, for particular devices, patients 14 and physicians, as well as generalized health information and interfaces which may be presented on other, proprietary devices.

In addition to providing patient- and physician-centric applications, communications module 26 may provide such applications while allowing implantable medical devices 12 to become or maintain relatively small size and form factor, as well as to attain or maintain relatively low power consumption. By not needing to communicate over communication bands and according to communication standards which utilize relatively large antennas and consume relatively large amounts of power, such as those found on host devices 24 listed above, implantable medical devices 12 can use relatively short-range, low-power communications schemes such as those typically and historically utilized on implantable medical devices 12 while still maintaining the benefits of long-range communications. In so doing, the relatively small form factors and low power consumption of implantable medical devices 12 may be maintained.

It is to be recognized and understood that other sensors 40 may be utilized, including and without limitation, in an embodiment, one or motion sensors (e.g., a motion sensor positioned with respect to the body core and a motion sensor positioned with respect to an extremity), one or more tilt sensors (e.g., to assist in determining either a position of the body, an angle of repose of the body or both), and one or more oxygen sensors. Any and all of sensors 40 could communicate with host device 24 by way of communications module 26. Further, any and all of sensors 40 may also communicate with each other, or some of the other sensors 40, by way of, for example, a body area network 42 using, for example the MICS/MEDS band.

In an exemplary embodiment, body area network 42 may be utilized to communicate not only with any and all of sensors 40 but also may communicate with implantable medical device 12 or multiple implantable medical devices 12. Any and all of such implantable medical devices may communicate not only with each other and with any and all of such sensors 40 but also may communicate with host device 24 through communications module 26 using, for example the MICS/MEDS band.

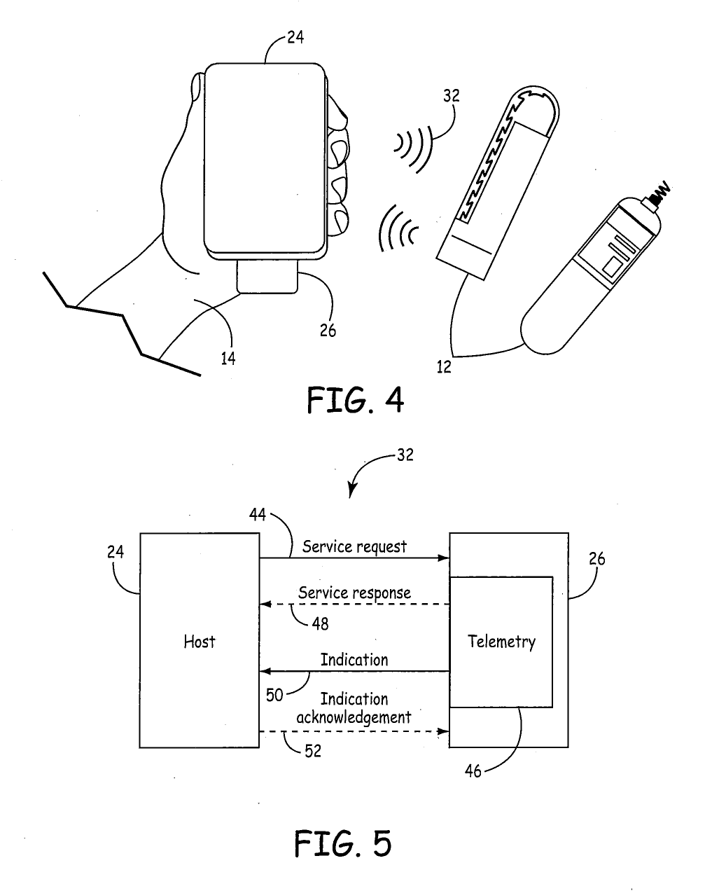

FIG. 4 is an example depiction of a graphical application for host device 24 configured to facilitate interfacing with implantable medical devices 12. As depicted, the application provides data to patient 14 relating to the conduction of a basic exercise program or “basic workout”. In such an embodiment, implantable medical device 12 may be related to providing a physiologic status of patient 14, such as blood pressure or heart rate. Because various host devices 24 incorporate different operating systems and different hardware, the various applications which are developed may be adapted for different host devices 24. For host devices 24, which incorporate a common operating system and the same or similar hardware, applications may be developed which are cross-functional.

FIG. 5 is a diagram illustrating an example series of communications 32 between host device 24, the communications module and implantable medical device 12. In particular, FIG. 5 illustrates example steps by which host device 24 initiates communication with implantable device 12 by making a service request 44 to telemetry module 46 of communications module 26 and receiving service response 48. Services which may be requested include, but are not necessarily limited to, a command to initialize, discover the presence of medical device 12, open communications, obtain data and close communications. FIG. 5 further illustrates the initiation of communication or, alternatively, the response to the service request by the communications module by transmitting indication signal 50. Such functions may be implemented in firmware on communications module 26 and may be acknowledged with indication acknowledgement 52.

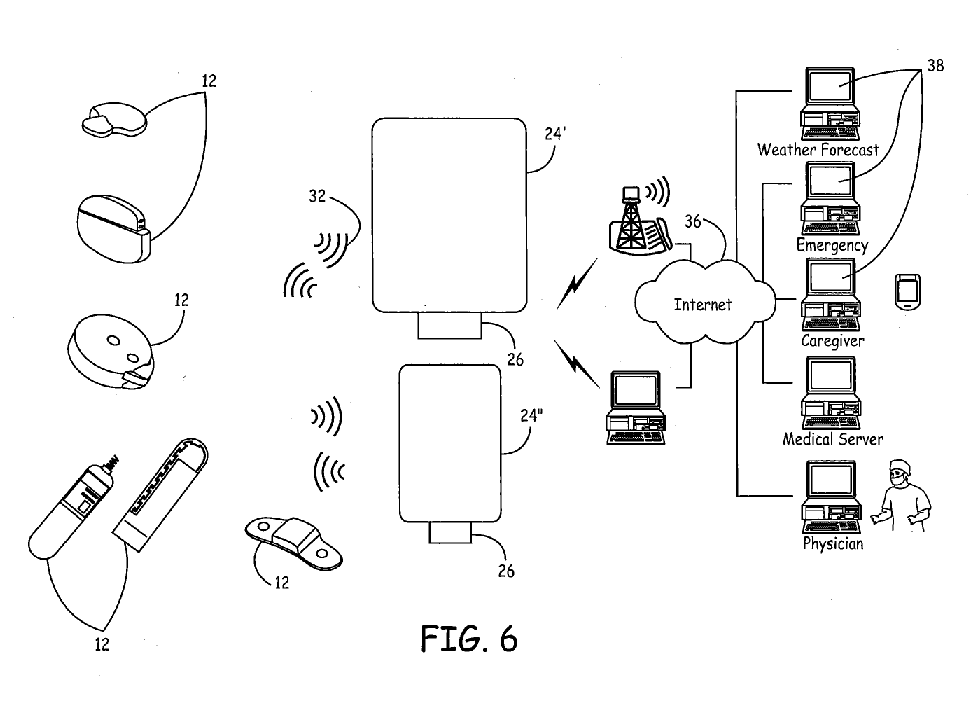

FIG. 6 is a depiction of utilizing multiple host devices 24 of varying types to communicate 32 with multiple medical devices 12 and to facilitate communications between and among multiple medical devices 12, host devices 24 and the third-party devices 38 over the Internet 36. As illustrated, both a tablet computer host device 24′ and a smartphone host device 24″, in an embodiment an iPad™ tablet computer and an iPhone™ smartphone, respectively, are configured to communicate 32 with various medical devices 12, both implantable and non-implantable. The presence of multiple medical devices 12 and multiple host devices 24 need not interfere with the ability of various medical devices 12 and host devices 24 to communicate with one another.

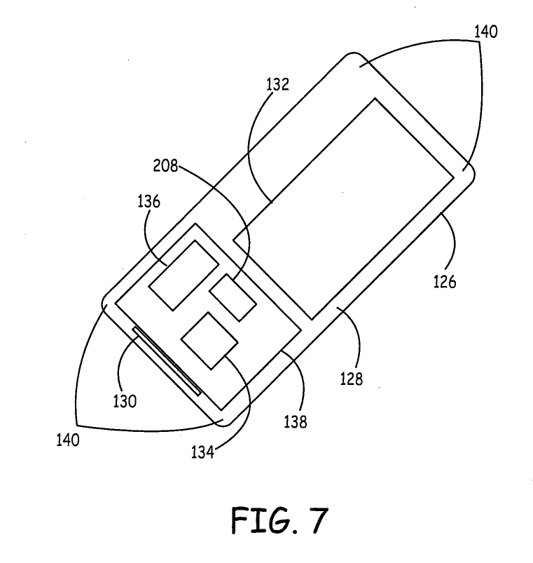

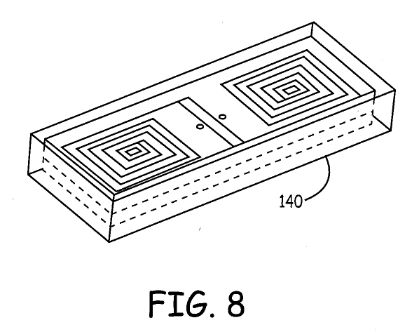

FIG. 7 is a depiction of an alternative embodiment of communications module 126. Rather than being a plug-in-style module 26 as shown, for instance, in FIG. 2, the communications module of FIG. 7 is incorporated in a casing or “skin” 128 to which host 24 device may be positioned, e.g., by “skin” 128 partially enveloping host device 24. As illustrated, casing 128 incorporates connector or data cord 130 to physically interface with host device 24. Electronics, including battery 132, processor 134, memory 136, motherboard 138 and antenna 140 are incorporated into the casing. Such components may be incorporated so as to be relatively flush with casing 128, thereby reducing the extent to which casing 128 increases the form factor of host device 24 relative, for instance, to the dongle implementation of communications module 26.

It is to be recognized and understood that, while the embodiments described above depict communication module 26, 126 configured to make a physical connection with host device 24, alternative embodiments of communication module 26 may be implemented. In particular, communication module 26 may be configured to operate without a physical connection to host device 24. In such embodiments, communication module 26 may have a power source such as battery 132 independent of host device 24 and may communicate with host device 24 according to various communication schemes detailed above with respect to communication between communication module 26 and medical device 12. Such communication schemes may include, but are not necessarily limited to, cellular, Bluetooth and WiFi. In such embodiments, host device 24 may be configured to maintain wireless communications with third party devices 38 according communication schemes described above, including, in various embodiments, the same scheme utilized for communications between communication module 26 and host device 24, without inhibiting communications between host device 24 and communication module 26 and the third party devices 38.

Providing patients 14 and physicians with relatively greater access to information and control of medical devices 12 may be beneficial in terms of the ability of patient 14 to understand and improve their own condition and the ability of a physician to treat patient 14. However, the proliferation of information and control may have side effects which may be mitigated. In particular, if a third party were to be able to access host device 24 with a coupled communication module 26, the third party may be able access personal and sensitive information about patient 14 and may, in certain circumstances, be able to impact the performance of patient's 14 device 12.

Medical device systems have traditionally incorporated security features to prevent unauthorized access. However, because such systems have traditionally been based on proprietary devices, the security systems have not had to function in the context of devices outside of the control of the medical device manufacture and trusted users such as medical professionals. In addition, because the devices are proprietary, the manufacturer of the system has been able to control access to the devices, which may, in some circumstances, lessen the risk of an unauthorized party gaining access to the system. The move to off-the-shelf, commercially available consumer devices modified with a relatively small and inexpensive module may create added opportunities for access by an unauthorized third party which may be addressed through additional security measures which may be presented by the characteristics of the host device itself.

FIG. 8 is an embodiment of antenna 140 of communication module 26. Antenna 140 is configured to communicate conventionally with medical devices 12, thereby providing wireless telemetry capabilities. In order to maintain a relatively small form for communication module 26, antenna 140 is configured to be compact. In various embodiments, antenna 140 is a notch antenna. Antenna 140 may incorporate tuning capacitors that may improve communications in various environmental conditions. Similarly, antenna 140 may be trimmed on the basis of the available size of communication module 26.

Antenna 140 may be utilized with a telemetry module of communication module 26. The telemetry board may be coupled to antenna 140 and utilize antenna 140 to communicate with medical device 12. In an embodiment, the telemetry board is approximately ten (10) millimeters by ten (10) millimeters and approximately 1.65 millimeters thick. In an embodiment, telemetry module consumes approximately six (6) milliamps of current and has a voltage of approximately 1.85 volts to approximately 3.5 volts.

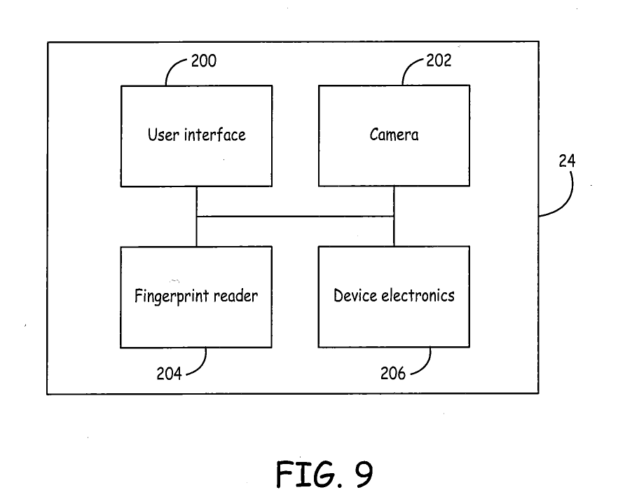

FIG. 9 is a block diagram of a simplified exemplary embodiment of host device 24. As illustrated, host device 24 incorporates hardware such as user interface 200, camera 202 fingerprint reader 204 and device electronics 206, including but not limited to device memory, communications interfaces, microprocessors and other device control hardware. In addition, various security features have been incorporated into host devices 24 as known in the art, including such as password locks and fingerprint identifiers managed by device electronics 206. Such features of the host devices may be incorporated into the security and patient-physician interaction systems provided by system 10 providing care for the patient, such as is illustrated in FIGS. 1, 3 and 6.

In embodiments where host device 24 incorporates camera 202, host device 24 may be modified with application software to use camera 24 for facial recognition using device electronics 206 to process images received from camera 24. Images of valid users, such as the patient, the patient's physician and a caregiver for the patient, such as a family member, may be stored in host device 24. In order to access the patient's information, the would-be user would have their picture taken by camera 202. The facial recognition software as operated on device electronics 206 may then compare the newly taken picture with the images of valid users. In the event the picture does not match up, host device 24 may deny access to patient information.

Similarly, in embodiments where host device 24 incorporates fingerprint reader 204 and fingerprint recognition system on device electronics 206, the host device may be loaded with application software to utilize the fingerprint identification system for the purposes of security for system 10. That is, it may be necessary for a user to provide an appropriate fingerprint for validation before the user may access system 10 or may access certain features of system 10. Note that in embodiments of host device 24 where fingerprint security is already utilized to access host device 24 itself, it may be made optional to require an additional fingerprint identification upon attempting to access medical device 12 applications. Instead, it may be determined that using the fingerprint identification to access host device 24 in the first instance is enough to allow for access to medical device 12 applications.

Facial recognition and fingerprint identification may be combined with one another and/or additional security measures, such as password protection and/or a public/private key arrangement to provide a suite of security features. Thus, in order to reduce an effectiveness of tampering, a user may be required to pass, for instance, both facial recognition and enter a password to access medical device 12 applications. In certain embodiments, temporary security measures may be passed to host device 24 from system 10 in order to allow temporary access to certain features of medical device 12 application. For instance, a particular password or key may be utilized to access certain functions not normally made available to a user. Such public-private key arrangements are well known in the art and may be managed from sites remote to host device 24. In various embodiments, communications may not be initiated with medical device 12 from communication module 26 until the user has been deemed authorized.

In an embodiment, a central validation server included in outside receptor 20 of system 10 may be utilized in the provision of a public/private key validation criteria. Identifications of communication modules 26 may be maintained in the central validation server. To initiate communications with medical device 12, communication module 26 may generate a request comprised of user credentials and medical device 12 information signed with a private key of communication module 26. The request may be transmitted to the central validation server. The central validation server may reply with a token granting or denying access and signed with the central server's private key. In various embodiments, the requested communication link with medical device 12 is granted or denied based on whether the requesting user is authorized to communicate with medical device 12. In an embodiment, the central validation server is configured to automatically deny access to communication modules 26 which have been reported as having been compromised by repeated failed validation conditions or having been reported as being lost or stolen.

In various additional embodiments, the central validation server of outside receptor 20 may be configured to provide additional security or access controls. In an embodiment, host device 24 and communication module 26 may only enable functions related to monitoring medical devices 12 until and unless a user meets a validation condition regulated by the central validation server to allow the use of functions relating to modifying the performance of medical device 12. In such embodiments, the central validation server may reject all attempts to modify medical device 12 which lack a proper validation condition. Alternatively, the central validation server may obtain and store attempted modifications of medical device 12 until the validation condition of the user is authenticated, whereupon the modifications may be transmitted to medical device 12. In such embodiments described above, once a session which has been validated for device modification has ended, host device 24 and communication module 26 may revert to only utilizing monitoring functions until the programming validation condition has been met. In certain embodiments, applications for modifying medical devices 12 may be downloaded to host device 24 and communication module 26 only upon the modification validation condition having been met.

It is noted that the central validation server may provide storage for instances both of successful and unsuccessful attempts to modify medical devices 12. In such instances, the storage of dates, times, and old and new device settings may provide data relevant in determining medical device 12 performance, potential security complications and reimbursement for services.

Power savings may be realized by preventing extraneous communications with medical device 12. In an embodiment, user validation on host device 24 may be required before communications module 26 is allowed to communicate with medical device 12. Since communication with medical device 12 may not occur before user validation, power in medical device 12 is saved by not requiring medical device 12 to be involved or use extraneous power during a potentially unsuccessful validation process.

In addition to electronic or visual security measures, it may be desirable, for actions such as reprogramming medical device 12, to require a physical activity and/or physical proximity to provide authorization to execute the action. For instance, in an embodiment, communication module 24 is configured with proximity sensor 208 (FIG. 7) which detects a close proximity, in various embodiments from a few centimeters to one meter, of medical device 12 to be reprogrammed. Shorter or longer ranges are also envisioned. When a command to reprogram medical device 12 is entered at a remote site, such as by a physician in a clinic 28, the patient may be prompted to place communication module 26 close enough to medical device 12 to trigger proximity sensor 208. Such a system may increase a likelihood that the patient is aware that medical device 12 is to be reprogrammed and acquiesces to the change. Proximity sensor 208 may be utilized to authorize various other functions of host 24, communication module 26 and medical device 12.

Power may be saved by not initiating communications unless it is already known that medical device 12 is within communication range. For example, host device 24 may determine that communication module 26 is in proximity, e.g., close proximity as described above, with medical device 12 and that communication based on such proximity authorization has been established before allowing communications module 26 to conduct communication with medical device 12. Since, in such an embodiment, communication with the medical device 12 is not conducted unless and until proximity is established and authorization is established, power of medical device 12 is preserved during the authorization process. Further, since proximity may be required before conducting communication, power of medical device 12 is not wasted in non-fruitful attempted communication which fails because medical device 12 and communication module 26 are too far apart. As another example, in a particular communication mode 26, Bluetooth, for instance, may not be enabled unless and until medical device 12 and communication module 26 are in close proximity, thus saving power of any of medical device 12, communication module 26 and host device 24 that would otherwise utilize such a communication mode.

A corollary to the availability of camera functionality in host device 24 utilized for security validation is the ability to incorporate software applications in device electronics 206 which may usefully take advantage of images of the patient. For instance, a software application may be utilized by being incorporated into host device 24 or run from communication module 26, which provides for biometric indications of the patient's condition based on a camera image. Alternatively, the image of the patient may be sent to a remote site in system 10 where biometric information may be determined and factored into decisions regarding the treatment of the patient. In addition, the camera feature may be utilized in conducting remote follow-ups between a patient and physician. In various embodiments, the follow-up procedures are conducted real time. By being visible to the physician the patient may be better diagnosed and interacted with. In these various ways, the camera function may be used dually for both validation and obtaining a biometric read of the patient to aid diagnosis and/or treatment of the patient.

In addition to camera-based biometric indications, other biometric conditions may be sensed by various components of system 10. Handwriting, iris and voice analysis may also be applied. Such information may be utilized both for validation conditions and for patient diagnosis, as applicable.

Still further, in an embodiment, the camera of the host device may be used for purposes other than, or in addition to, security. In an embodiment, the camera may assist a physician or other caregiver in facilitating a remote visit between the caregiver and the patient, a so-called “evisit.” Not only can camera 202 provide a useful security function, but the camera can also be used, in conjunction with information derived from an implantable medical device or other sensor, to assess the condition of the patient and, possibly, assist with diagnosis.

In addition to providing an either/or, access or no access condition to the functionality of the host device, as alluded to above, the various security functions which may be incorporated and modified from host device 24 may be utilized to provide variable access to host device 24 and communication module 26 features and functionality. For instance, a single host device 24 and communication module 26 may be configured for use by any user, whether patient, physician or patient caregiver. However, based on the determination of a user login and verification by the security systems, portions of the functionality of host device 24 and communication module 26 may be made unavailable to that particular user. In addition to utilizing security features, host device 24 or communication module 26 may incorporate a physical switch to switch between different modes.

As described in detail herein, host device 24 and communication module 26 each incorporate a plurality of functions. Some of the functions are related to interfacing with medical devices 12 and others of which, particularly in the case of host device 24, may not be related to interfacing with medical devices 12. The functions, and particularly those related to interfacing with medical devices 12, may be incorporated into a plurality of validation layers, each validation layer corresponding to at least one validation condition or activation criterion. When a validation condition for a validation layer is met, the functions associated with the validation layer become available for use.

The use of various functions may thereby be controlled by associating particular validation layers with particular users having particular characteristics. A patient may be associated with validation layers providing functions which provide relatively minimal amounts of patient and medical device 12 information and, in certain embodiments, relatively few to no functions for modifying a performance of medical device 12. A medical professional such as a physician, however, may be associated with validation layers corresponding to functions which are not associated with the patient and which provide substantial to full access to patient and device data and extensive capacity to modify a performance of medical device 12. In various embodiments, the medical professional has access to the same validation layers as the patient.

In one exemplary embodiment, when a patient logs in to host device 24 and provides accurate validation information, host device 24 and communication module 26 may be configured to download information about the patient's condition from medical device 12. Host device 24 may display the information to the patient on user interface 200, allowing the patient to monitor the patient's condition. However, the patient may not be given additional functionality, such as to modify the performance of the medical device.

In the exemplary embodiment, it may be that a different user, such as a caregiver who is relatively more sophisticated and capable than the patient, may be enabled to utilize host device 24 to monitor the patient's condition and to make relatively modest changes in the patient's treatment. Such modest changes may include modest changes in therapy delivery or the delivery of bolus doses of drugs to the patient. Alternatively, a patient who was previously determined to not be capable of managing their own therapy may subsequently be trained in caring for themselves or otherwise deemed capable of personal care and have their access changed to allow more control over their therapy. The reverse may also be applied in certain circumstances.

In an embodiment, a single host device 24 and/or communication module 26 could be used by not only the patient and a physician, or professional caregiver, as described above, but also by a third caregiver, a person perhaps more skilled than the patient or better situated to assist the patient but still not as skilled as a professional caregiver, such as a physician. In this situation, a third validation layer may be provided. A first validation layer or collection of validation layers could provide the patient or other limited caregiver with a certain subset of functions of system 10, a second validation layer or collection of validation layers for a higher level caregiver, e.g., family member, friend, nurse's aid, hospice worker, could provide a different subset of functions of the system, perhaps a greater range. And, as described above, a third validation layer or collection of validation layers could be provided to the physician, PA or the like, to allow access to yet another set of functions of the system, perhaps an even greater range of functions or perhaps a full range of functions. In this way, a single host device 24 and/or communication module 26 can be multi-purposed for different individuals performing, perhaps, different tasks, yet providing security to ensure that each individual has access to functions appropriate to their security level and only functions appropriate to their security level.

In any of the embodiments described above, a single device could be used by different users with for different functions, or a different subset of functions, but instead of selection of functions by authorization, such different functions or subsets of functions could be made available through the use of a switch, either a hardware switch or a soft switch on user interface 200. Such may be appropriate in situations where there is not a need for security between levels of users. Alternatively, the use of a switch, again either a hardware switch or a soft switch on user interface 200, could be used in conjunction with a validation procedure, such as one or more of the validation procedures described above, to provide differing users with differing functions. This may be advantageous, for example, when differing levels of security are desired and, in addition, it is desired to have a positive selection and/or positive feedback to the mode of operation of system 10.

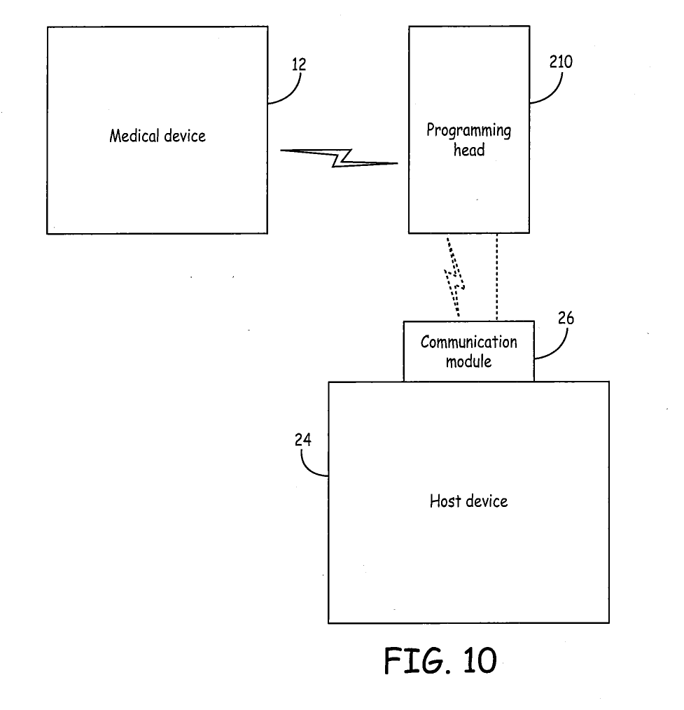

Continuing with the exemplary embodiment, a physician may be given complete or relatively complete access to all functionality of host device 24 upon logging in and providing validation of the physician's identity. Alternatively, the physician's access may be limited based on the proximity of the physician to the patient. FIG. 10 is a functional drawing of programming head 210 in communicative contact with implantable medical device 12, host device 24 and communication module 26. Programming head 210 is variably configured to communicate wirelessly with at least one of host device 24 and communication module 26 or to conduct wired communication with at least one of host device 24 and communication module 26. Programming head 210 is, in various embodiments, configured to communicate with medical device 12 via inductive telemetry and relatively short range radio frequency communication.

Variable access for a physician may be provided if the physician indicates proximity to the patient by plugging in and utilizing physical programming head 210 which is placed proximate medical device 12 in order to program medical device 12. Under such circumstances, it may be understood that the physician is present with the patient and fully aware of the condition of the patient. By contrast, when the physician has not plugged programming head 210 into host device 24, for instance, the physician may be limited in the programming options available to the physician. In various embodiments, the physician may be enabled to make relatively minor changes to the functionality of medical device 12, though the possible changes may exceed those available to a caregiver or sophisticated patient. In further embodiments, the physician may be granted full access to modify medical device 12 if the physician manually overrides the restrictions or the patient deliberately acquiesces to the change in the performance of their medical device 12.

As noted above, the function of host device 12 may be extended by allowing programming head 210, for direct telemetry communication with an implantable medical device 12, to be coupled, perhaps plugged in either directly or by tether, to communication module 26. Since communication module 26 is already in communication with host device 24, the combination of host device 24, communication module 26 and programming head 210 can be used to conduct telemetry communications with medical device 12 using user interface 200 of host device 24 without requiring a dedicated patient or physician programmer.

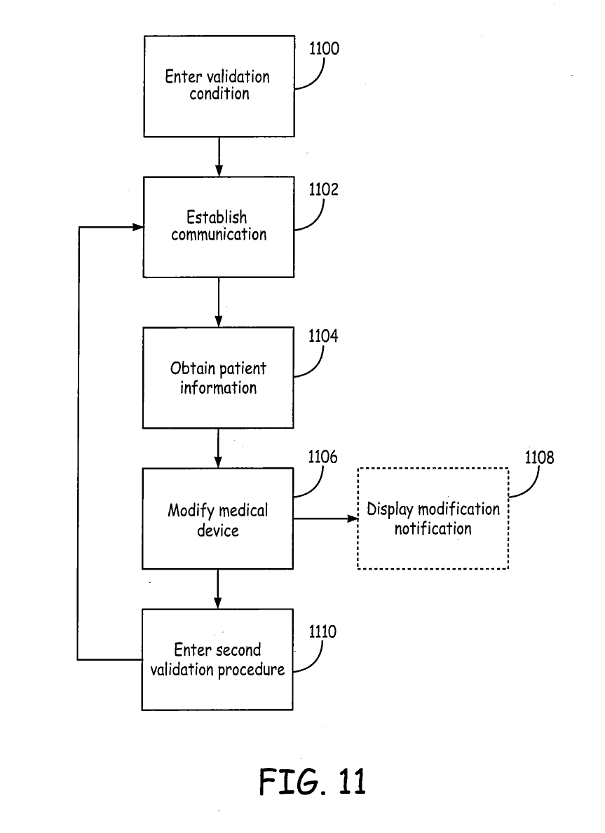

FIG. 11 is a flowchart for interfacing with medical device 12 using host device 24 and communication module 26. As discussed in detail above, at least one of host device 24 and communication module 26 have a plurality of validation layers configured for use by various users, including patients, caregivers and medical professionals, such as physicians. Each of the users have access to various ones of the validation layers based on a validation condition. Various ones of the functions of host device 24 and communication module 26 are associated with individual ones of the plurality of validation layers and are operational to interface with medical device 12 only when a corresponding validation condition is met.

A validation condition corresponding to one of the users is entered (1100) via user interface 200 for at least one of the validation layers. Communication (1102) is established with medical device 12 according to the functions associated with the at least one of the validation layers upon entering the validation condition. A patient condition may then be obtained (1104) via user interface 200 and/or a performance of medical device 12 may be modified (1106). If a performance of medical device 12 is modified (1106), a notice of modification may be displayed (1108) on user interface 200 to a medical professional. A peripheral device such as programming head 210 may be incorporated into system 10 to provide a validation condition for one of the validation layers. The validation condition may, in various embodiments, be a simple connection by which programming head 210 is locally coupled to system 10, or may involve a passcode transmission from programming head 210 to system 10. A validation layer may have a validation condition which utilizes a first validation procedure and a second validation procedure les complex than the first validation procedure and which may be utilized after the first validation procedure. The validation condition entered (1100) may be the first validation procedure, and subsequent second validation procedures may be entered (1110), which may be followed by communication (1102) with medical device 12.

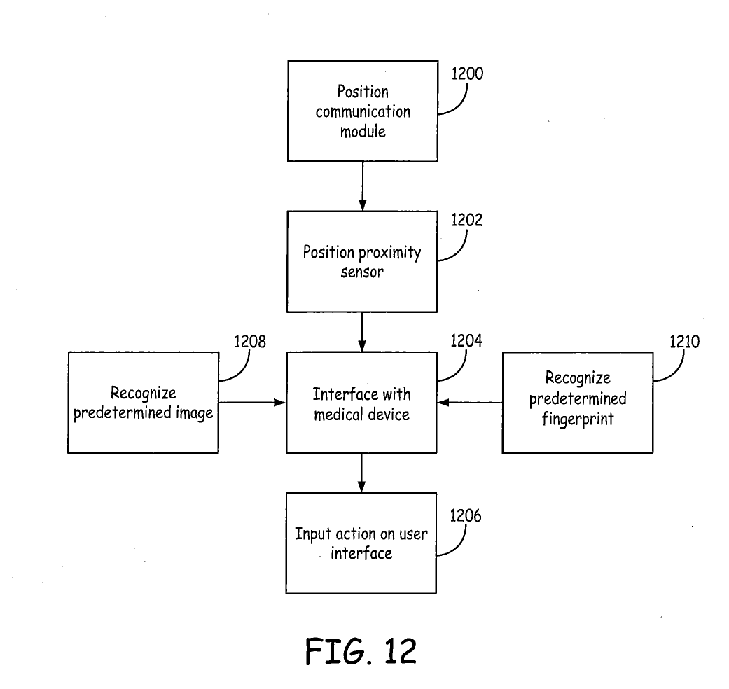

FIG. 12 is a flowchart for interfacing with medical device 12 using host device 24, communication module 26 and proximity sensor 208, proximity sensor having a second range of wireless communication less than a first range of wireless communication of communication module 26. The communication module 26 is configured to communicate with medical device 12 only upon an activation criterion based on proximity sensor 208 having been met. Communication module 26 is positioned (1200) within the first range of wireless communication with medical device 12. Proximity sensor 208 is positioned (1202) within the second range of wireless communication with medical device 12. Then, communication module 26 interfaces (1204) with medical device 12 based on the activation criterion having been met.

In an embodiment, the activation criterion is further met by inputting (1206) an action on user interface 200. In an embodiment, the activation criterion is further met by recognizing (1208) a predetermined image obtained from camera 202 and as recognized by software of an image recognition block of device electronics 206 of host device 24. In an embodiment, the activation criterion is further met by recognizing (1210) a predetermined fingerprint obtained from fingerprint reader 204 using a fingerprint recognition block of device electronics 206 of host device 24.

Thus, embodiments of the invention are disclosed. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A system for interfacing with a medical device, comprising:
a host device comprising a user interface configured to input and display information relating to said interfacing with said medical device; and
a communication module locally coupled to said host device and configured to communicate wirelessly with said medical device;
wherein said system, implemented by said host device and said communication module, is configured to communicate with said medical device with a plurality of functions;
wherein said system, implemented by at least one of said host device and said communication module, has a plurality of validation layers configured for use by a plurality of users, each of said plurality of users having access to at least one of said plurality of validation layers based on a validation condition, each individual one of said plurality of functions being operational through said user interface only with one of said plurality of validation layers.

2. The system as in claim 1 wherein each individual one of said plurality of users corresponds to individual ones of said plurality of validation layers based on a characteristic of said individual one of said plurality of users.

3. The system as in claim 2 wherein one of said plurality of users is a patient and another one of said plurality of users is a medical professional, and wherein said at least one of said plurality of validation layers corresponding to said medical professional includes least one of said plurality of validation layers not corresponding to said patient

4. The system of claim 3 wherein said at least one of said plurality of functions corresponding to said at least one of said plurality of validation layers corresponding to said patient provide an indication of a patient condition from said medical device.

5. The system of claim 4 wherein said at least one of said plurality of functions corresponding to said at least one of said plurality of validation layers corresponding to said medical professional provide modification of a performance of said medical device.

6. The system of claim 5 wherein a notice of a modification of said performance of said medical device is displayed on said user interface to said medical professional when said modification of said performance of said medical device is modified.

7. The system of claim 6 wherein one of said plurality of users is a caregiver and wherein said at least one of said plurality of validation layers corresponding to said caregiver includes at least one of said plurality of validation layers not corresponding to said patient and wherein said at least one of said plurality of validation layers corresponding to said medical professional include at least one of said plurality of validation layers not corresponding to said caregiver.

8. The system of claim 1 wherein said system further comprises a peripheral device and wherein at least one validation condition of a corresponding one of said plurality of validation layers is based on said peripheral device being locally coupled to said system.

9. The system of claim 1 wherein at least one of said validation conditions is based on a first validation procedure and a second validation procedure utilized after a first use of said first validation procedure.

10. The system of claim 1 wherein said first validation procedure has a complexity greater than a complexity of said second validation procedure.

11. A system for interfacing with a medical device, comprising:
a host device comprising a user interface configured to input and display information relating to said interfacing with said medical device;
a communication module locally coupled to said host device, said communication module having a first range and being configured to communicate via radio frequency with said medical device; and
a proximity sensor locally coupled to said host device and said communication module, said proximity sensor having a second range being less than said first range and an activation criterion;
wherein said system interfaces with said medical device only upon said activation criterion being met.

12. The system of claim 11 wherein said proximity sensor is operatively coupled to said user interface and wherein an action on said user interface further provides said activation criterion.

13. The system of claim 11 wherein said system further comprises:
a camera having an output; and
an image recognition block operatively coupled to said output of said camera;
wherein said activation criterion is based on said image recognition block recognizing a predetermined image.

14. The system of claim 13 wherein said image recognition block is a facial recognition block configured to recognize a face of at least one of a patient, a caregiver and a medical professional.

15. The system of claim 13 wherein said image recognition block is configured to recognize a biometric attribute of a user.

16. The system of claim 11 wherein said system further comprises:
a fingerprint reader having an output; and
an fingerprint recognition block operatively coupled to said output of said fingerprint reader;
wherein said activation criterion is based on said fingerprint recognition block recognizing a predetermined fingerprint.

17. A method for interfacing with a medical device using a host device and a communication module together configured to communicate with said medical device with a plurality of functions, said host device comprising a user interface configured to input and display information relating to said interfacing with said medical device, said communication module being locally coupled to said host device and configured to communicate wirelessly with said medical device, at least one of said host device and said communication module has a plurality of validation layers, configured for use by a plurality of users, each of said users having access to individual ones of said plurality of validation layers based on a validation condition, each individual one of said plurality of functions being associated with at least one of said plurality of validation layers and being operational through said user interface only with one of said plurality of validation layers associated with said individual one of said plurality of functions, said method comprising the steps of:
entering said validation condition via said user interface and corresponding to one of said plurality of users for at least one of said plurality of validation layers; and
communicating with said medical device according to said at least one of said plurality of functions associated with said at least one of said plurality of validation layers upon said entering said validation condition.

18. The method as in claim 17 wherein one of said plurality of users is a patient and another one of said plurality of users is a medical professional, and wherein said communicating step comprises communicating based on said at least one of said plurality of validation layers corresponding to said medical professional including at least one of said plurality of validation layers not corresponding to said patient.

19. The method of claim 18 wherein said at least one of said plurality of functions corresponding to said at least one of said plurality of validation layers corresponding to said patient provide an indication of a patient condition from said medical device, and further comprising the step, after said entering said validation condition step, of obtaining an indication of said patient condition via said user interface.

20. The method of claim 19 wherein said at least one of said plurality of functions corresponding to said at least one of said plurality of validation layers corresponding to said medical professional provides modification of a performance of said medical device, and further comprising the step, after said entering said validation condition step, of modifying a performance of said medical device.

21. The method of claim 20 further comprising the step of displaying a notice of a modification of said performance of said medical device on said user interface to said medical professional when said modification of said performance of said medical device is modified in said modifying step.

22. The method of claim 21 wherein one of said plurality of users is a caregiver and wherein said at least one of said plurality of validation layers corresponding to said caregiver includes at least one of said plurality of validation layers not corresponding to said patient and wherein said at least one of said plurality of validation layers corresponding to said medical professional includes at least one of said plurality of validation layers not corresponding to said caregiver and wherein said communicating step is based, at least in part, on said at least one of said plurality of validation layers corresponding to said caregiver.

23. The method of claim 17 wherein said system further comprises a peripheral device and wherein said communicating step is based, at least in part, on at least one validation condition of a corresponding one of said plurality of validation layers being based on said peripheral device being locally coupled to said system.

24. The method of claim 17 wherein at least one of said validation conditions is based on a first validation procedure and a second validation procedure utilized after a first use of said first validation procedure;
wherein said entering step comprises using said first validation procedure; and further comprising the step, after said entering step, of:
entering said validation condition via said user interface using said second validation procedure.

25. The method of claim 24 wherein said entering said validation condition via said user interface using said second validation step occurs after said communicating step.

26. The method of claim 24 wherein said first validation procedure has a complexity greater than a complexity of said second validation procedure.

27. A method for interfacing with a medical device using a host device, a communication module and a proximity sensor, said host device having a user interface configured to input and display information relating to said interfacing with said medical device, said communication module being locally coupled to said host device, said communication module having a first range and being configured to communicate via radio frequency with said medical device, said proximity sensor locally coupled to said host device and said communication module, said proximity sensor having a second range less than said first range and an activation criterion, wherein said system interfaces with said medical device only upon said activation criterion being met, the method comprising the steps of:
positioning said communication module within said first range of said medical device;
positioning said proximity sensor within said second range of said medical device; then
interfacing with said medical device using said communication module based on said activation criterion being met.

28. The method of claim 27 wherein said proximity sensor is operatively coupled to said user interface and further comprising the step of inputting an action on said user interface to further provide said activation criterion, and further comprising the step, prior to said interfacing step, of inputting said action via said user interface.

29. The method of claim 27 wherein said system further comprises:
a camera having an output; and
an image recognition block operatively coupled to said output of said camera;
further comprising the step of recognizing a face of at least one of a patient, a caregiver and a medical professional using said image recognition block; and
wherein said interfacing step is further based, at least in part, on said activation criterion based on said image recognition block recognizing said predetermined image step.

30. The method of claim 27 wherein said system further comprises:
a fingerprint reader having an output; and
an fingerprint recognition block operatively coupled to said output of said fingerprint reader;
further comprising the step of recognizing a predetermined fingerprint of at least one of a patient, a caregiver and a medical professional using said fingerprint recognition block; and
wherein said interfacing step is further based, at least in part, on said activation criterion being based on said fingerprint recognition block recognizing said predetermined fingerprint.
